(19) United States
(12) Patent Application Publication
(10) Pub. No.: US 2021/0394961 A1
(43) Pub. Date: Dec. 23, 2021

(54) Disposable, Physical Barrier for Containers

(71) Applicant: Michael Z. Grace, Pittsburgh, PA (US)

(72) Inventor: Michael Z. Grace, Pittsburgh, PA (US)

(21) Appl. No.: 17/352,267

(22) Filed: Jun. 19, 2021

Related U.S. Application Data
(60) Provisional application No. 63/041,253, filed on Jun. 19, 2020.

(51) Int. Cl. B65D 25/36; C09J 7/21; C09J 7/22; C09J 7/28

(52) U.S. Cl. CPC B65D 25/36; C09J 7/28; C09J 7/22; C09J 7/21

(57) ABSTRACT

The present invention provides a disposable, physical barrier for a container, such as a condiment container, in public settings in order to prevent transfer of microorganisms from one user to another user of the container. The barrier is manufactured from sheet material which can be configured on a roll, a dispenser, or contained in a receptacle for easy, one-time use, thus ensuring that a user of a condiment container does not touch the same surface touched by a previous user.

### CROSS REFERENCE TO RELATED APPLICATIONS

This application claims priority to U.S. Provisional Patent Application No. 63/041,253, filed Jun. 19, 2020, which is incorporated herein by reference in its entirety.

### FIELD OF THE INVENTION

The present invention relates generally to the health and safety of the general public and, more specifically, to a disposable, physical barrier for publicly used condiment containers.

### BACKGROUND OF THE INVENTION

Many food establishments, such as restaurants, concession stands, and food trucks have condiment containers accessible to the public to dress their food. The condiment containers are used by many different patrons without being sanitized or cleaned between each use resulting in the likely transfer of microorganisms from one patron to another. Additionally, the condiments may leak or discharge onto the caps and sides of the containers leaving the condiment containers unsightly, messy, and soiled. Present condiment containers fail to provide a barrier to prevent cross-contamination of microorganisms between patrons of food establishments. There exists a need, therefore, for an effective and easy way to prevent such cross-contamination when using condiment containers in a public setting.

### SUMMARY OF THE INVENTION

The present invention fulfills this need by providing a disposable, physical barrier for a container, such as a condiment container, used in public settings for preventing transfer of microorganisms from one user to another user of the container.

In an aspect of the invention, there is provided at least a one-ply, barrier sheet including an adhesive side and a non-adhesive side, the barrier sheet rolled onto itself to form a roll with the adhesive side facing an internal core of the roll and the non-adhesive side facing externally outward with regard to the roll. The barrier sheet includes a plurality of perforated horizontal lines and a plurality of perforated vertical lines. At least a portion of the barrier sheet is configured to be removed from the roll at one of the plurality of perforated horizontal lines and at one of the plurality of perforated vertical lines. When removed, the barrier sheet is configured to be applied to an outside of the container.

In another aspect of the invention, there is provided at least a one-ply barrier sheet which is folded in half a plurality of times. The folded material is sealed at one edge to create a cylindrical shape configured to at least partially cover a portion of a condiment container.

In another aspect of the invention, there is provided a two-ply barrier sheet having a plurality of vertical perforated lines. The plurality of vertical perforated lines is placed between a first and a second rectangular section. The first rectangular section has a size that is larger than the second rectangular section. The first rectangular section includes three sealed edges and an open edge when removed from the roll by one vertical perforated line of the plurality of vertical perforated lines. Each removed large rectangular section forms a sleeve configured to cover a container. The rectangular section includes three sealed edges and an open edge when removed from the roll by at least one vertical perforated line of the plurality of vertical perforated lines. Each removed smaller rectangular section forms a smaller sleeve configured to at least partially cover a lid of the container.

In another aspect of the invention, there is provided a two-ply barrier sheet having a plurality of vertical perforated lines and one horizontal perforated line. The plurality of vertical perforated lines separates the barrier sheet into equal-sized rectangular sections. The horizontal perforated line separates the rectangular sections into a plurality of small rectangular sections and a plurality of large rectangular sections. Each of the plurality of large rectangular sections includes three sealed edges and an open edge when removed from the roll by one of the plurality of vertical perforated lines, with each of the removed large rectangular section forming a sleeve configured to at least partially cover a container. Each of the small rectangular sections of the plurality of small rectangular sections includes three sealed edges and an open edge when removed from the roll by the horizontal perforated line, with each of the removed small rectangular section forming a sleeve configured to at least partially cover a lid of the container.

In another aspect of the invention, there is provided a method for preventing transfer of microorganisms from one user to another user of a container, such as a condiment container, using the disposable, physical barrier described above. The method comprises having a user remove the barrier material from a roll, dispenser or receptacle and applying or fitting the removed barrier material to an outside of the condiment container.

### BRIEF DESCRIPTION OF THE DRAWINGS

A fuller understanding of the invention can be gained from the following description when read in conjunction with the accompanying figures, where like reference numerals refer to identical or functionally similar elements throughout the separate views, which illustrate some, but not the only and exclusive, examples of embodiments of the invention and, as such, the figures disclosed herein are to be considered illustrative rather than limiting. In the drawings:

FIG. 1 shows a first embodiment of the barrier in a roll formation;

FIG. 2 shows a perspective view of a condiment container wrapped in the barrier of FIG. 1;

FIG. 3 shows a perspective view of another embodiment of the barrier in a roll form;

FIG. 4 shows a perspective view of a further embodiment of the barrier in a roll form;

FIG. 5 shows a front view of the large rectangular section of the barrier used to cover the body or sides of the condiment container;

FIG. 6 shows a front view of the small rectangular section of the barrier used to cover the cap or lid of the condiment container;

FIG. 7 shows the condiment container covered by the large rectangular section;

FIG. 8 shows the condiment container with the lid or cap covered by the small rectangular section;

FIG. 9 shows the condiment container covered by a large rectangular section of the barrier and the lid or cap covered by the small rectangular section of the barrier;

FIG. 10 shows a perspective view of another embodiment of the barrier;

FIGS. 11A-F show perspective views of a box container, a hand roller dispenser, a hinged case dispenser, a stand dispenser, a container dispenser, and a portable dispenser, respectively; and

FIGS. 12A-E show front views (12A-C and 12E) and a perspective view (12D) of another embodiment of the barrier, with 12A showing the barrier before being folded in half (12B), with 12B folded in half again (12C), and folded in half one more time (12E), with 12D showing the barrier in its open configuration to allow a container to be placed therein.

### DETAILED DESCRIPTION OF THE INVENTION

A disposable, physical, barrier for containers is provided. Specifically, the barrier may be used for condiment containers such as ketchup, mustard, relish, mayonnaise, steak sauce, hot sauce, barbeque sauce, salt, pepper, and the like. The barrier is placed onto the container and can be discarded or overlaid with another barrier thereby eliminating the transfer of microorganisms left behind on the container from previous patrons. The barrier provides safety to patrons dining at food establishments by eliminating cross-contamination through the use of communal condiment containers. Additionally, the barrier provides a more aesthetic and clean condiment container by removing or covering condiment spill on the container from leakage or discharge of the condiment.

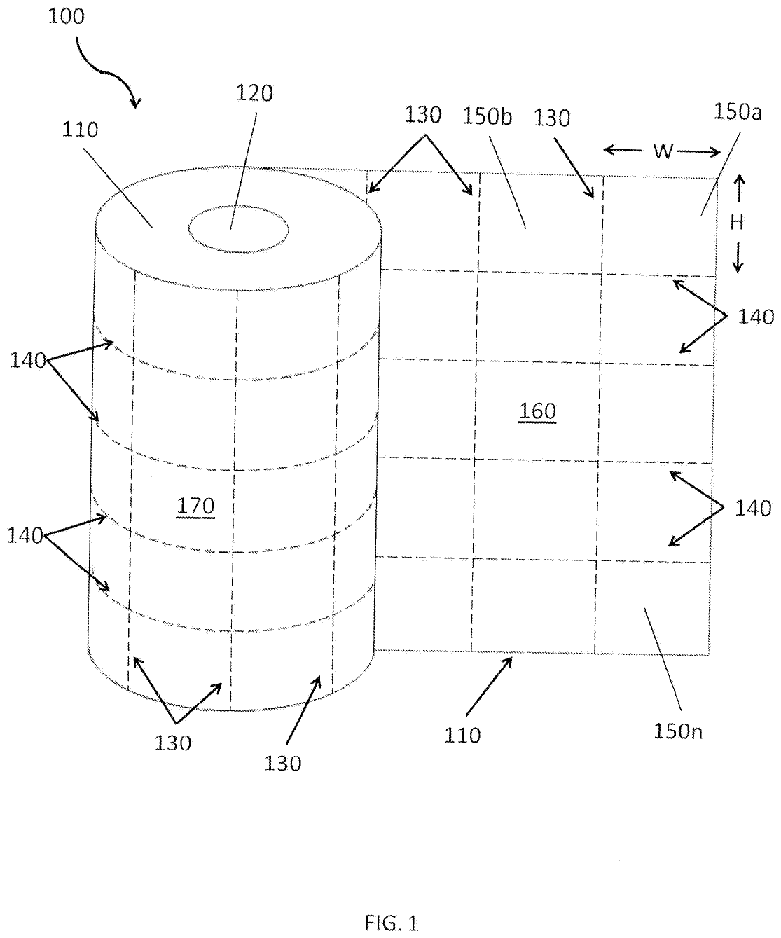

FIG. 1 shows a first embodiment of the disposable, physical, barrier 100 in a roll formation. The barrier 100 includes a sheet of material 110 wrapped to create a roll. The dimensions of the roll and sheet of material 110 may vary based on use and application. For instance, the size of the roll may depend on personal versus commercial use. Additionally, the height and thickness of the roll may depend on the dispensing device. The roll may have a height of 1 inch, 2 inches, 3 inches, 4 inches, 5 inches, or 6 inches. Although preferably the roll is manufactured in 1-inch increments, the roll may come in any increment between 1 inch and 7 inches.

The material 110 may be manufactured from any suitable material, including, without limitation, plastic, paper, polymer, cardboard, metal, and wax, or rice.

The material 110 preferably may have a thickness between 0.05 mm and 1.0 mm.

The roll includes a hollow core 120. The hollow core 120 may receive a rod or similar device to allow the roll to spin as a user tears off a portion of the material 110 for use. The hollow core 120 may include a keyway or gear to assist with spin control as the material 110 is dispensed from the roll. The sheet of material 110 includes a plurality of substantially parallel perforated vertical lines 130 and a plurality of substantially parallel perforated horizontal lines 140. The overlapping perforated vertical and horizontal lines create a plurality of rectangular sections 150a-150n. Alternatively, section 150a-n may be square or other geometric shape. Each rectangular section 150a-n may have a height H and width W that is approximately 1 inch. Although, preferably height H and width W is approximately 1 inch, the height H and width W may vary, for example height H and width W may be between 1 inch and 7 inches. The sheet of material 110 includes an adhesive side 160 and a non-adhesive side 170. The adhesive side 160 faces the interior of the roll. The non-adhesive side 170 faces the exterior. As the sheet of material 110 is rolled up, the adhesive side 160 contacts the non-adhesive side 170 of the previous layer. The non-adhesive side 170 may be anti-stick so the adhesive side 160 may be easily peeled from the non-adhesive side 170 as the sheet of material 110 is unrolled by a user. The adhesive side 160 may also include a top edge and bottom edge without adhesive to act as a tab to allow a user to easily grab and remove a predetermined portion. The top edge and bottom edge may be approximately 0.25 inches.

The user unrolls a length of sheet of material 110 and tears off a predetermined portion of the sheet 110 along a vertical perforated line 130. The removed portion of the material 110 can then be used to wrap around and cover at least a portion of a condiment container. A portion of the sheet 110 may further be torn along a horizontal perforated line 140 to cover different parts of the condiment container such as the lid or cap. The adhesive side 160 is placed onto the container and/or lid to allow the material 110 to cover and remain stationary on the container and/or lid. For example, the user may desire a 1-inch portion of the torn sheet to cover the condiment lid or cap while the remaining portion can be used to cover the side of the condiment container. Alternatively, the user may unroll a length of sheet of material 110 and tear the first vertical perforated line 130 to create a small strip of which both ends have omitted adhesive material. The thin strip may then be applied to the lid of the condiment container. The non-adhesive ends of the small strip provide an accessible tab for easy removal by the next user. The user may handle the condiment container by touching the covered portion of the container thereby eliminating any transfer of microorganisms left behind on the container from previous users. The user may continue to use the covered container multiple times once the barrier is applied. The non-adhesive side 170 may also be printed with words or images. For example, the food establishment may get its logo printed on the non-adhesive side so that the barrier 100 is promoting the food establishment. The non-adhesive side 170 may be printed with words or images and for other reasons as well.

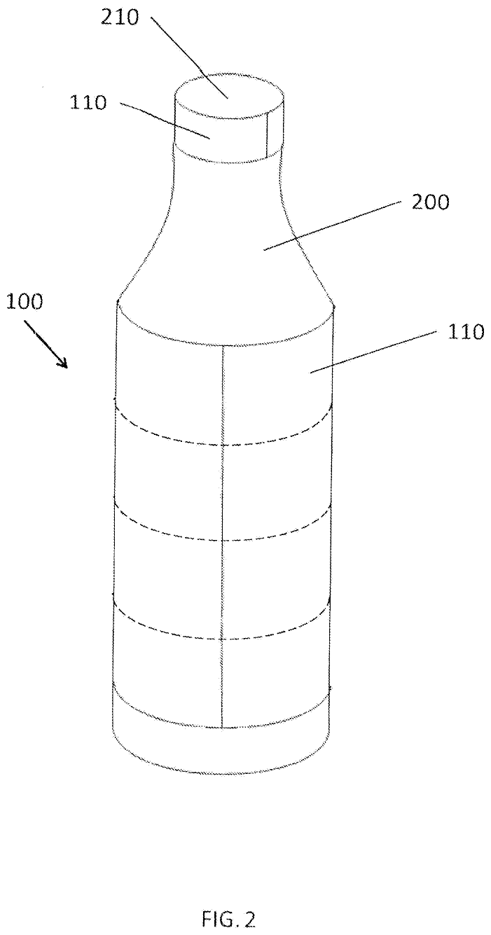

FIG. 2 shows a perspective view of a condiment container 200 wrapped in the physical barrier 100 of FIG. 1. As shown in FIG. 2, after the user has removed a portion of the sheet of material 110 from the roll, the sheet of material 110 may be used to cover the sides or body of the condiment container 200. The sheet of material 110 also may be used to cover or wrap the lid 210 of the condiment container 200. The user may use the condiment container without touching the container itself. The next user of the condiment container 200 can cover the material 110 with another layer of the material 110 so the previous layer of material 110 is covered. Alternately, the current user, next user, or an employee of the food establishment may remove the used barrier 100 and apply a new barrier 100. For example, an employee may remove and redress the condiment containers 200 with new barriers 100 each time a table is bussed and reset. No two users are forced to touch the same layer of the sheet of material 110 or the container 200.

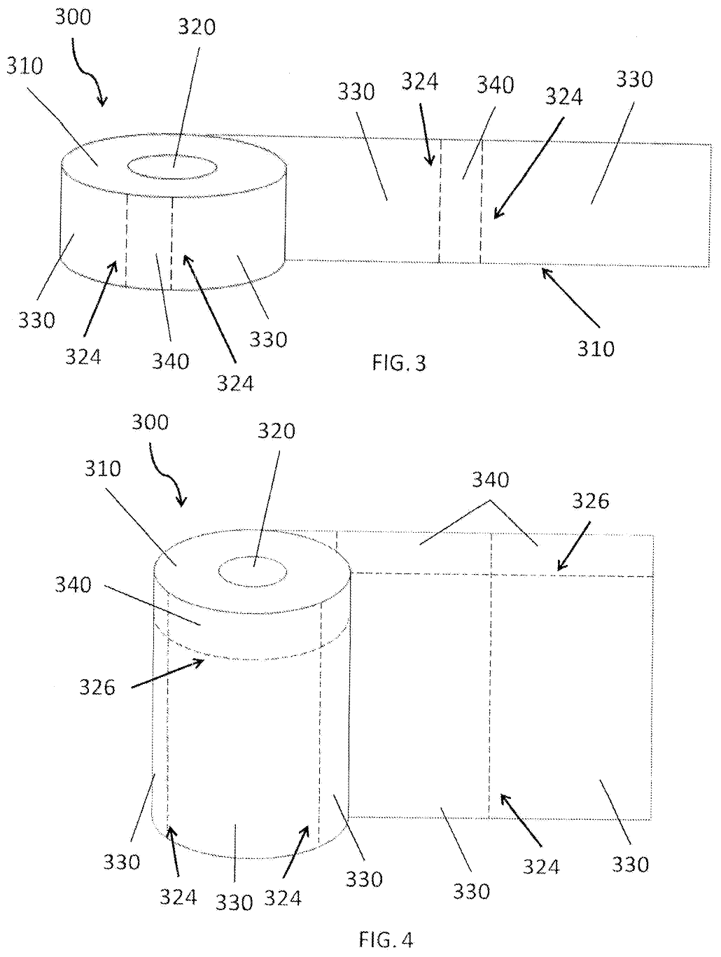

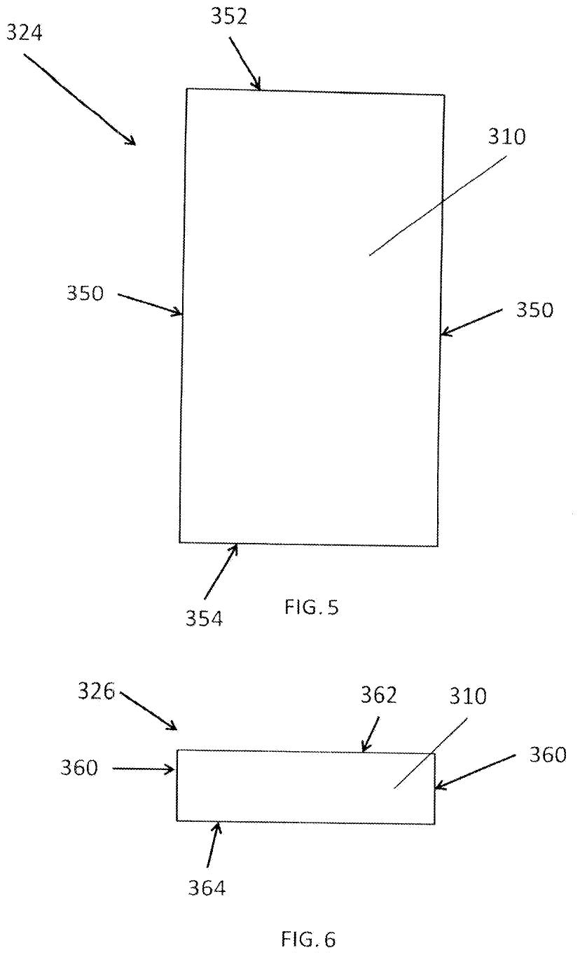

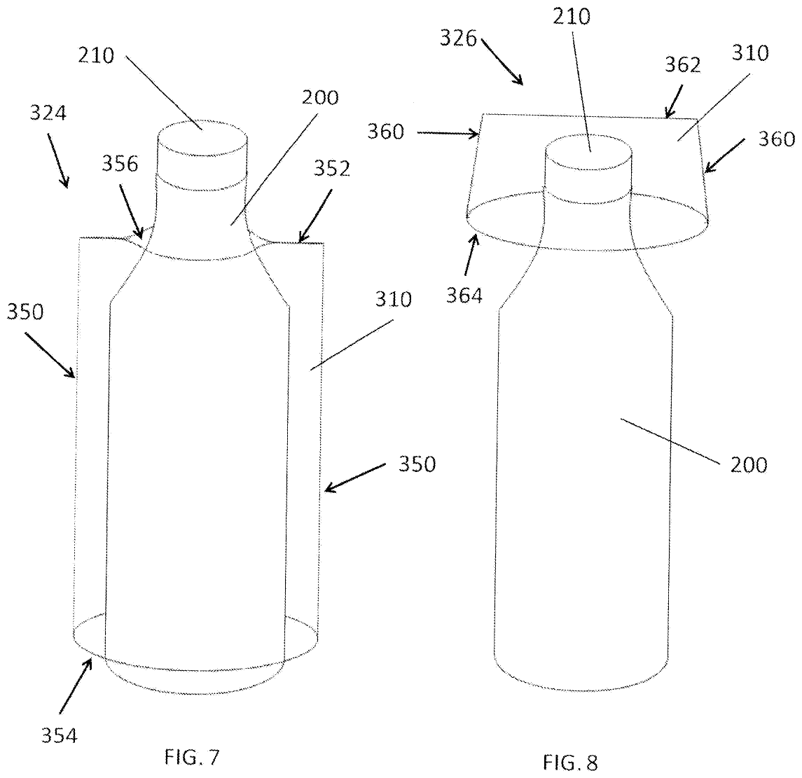

FIG. 3 shows a perspective view of the physical barrier 300 in a roll form. The barrier 300 includes a rolled-up sheet of material 310. The material 310 may be the same type of material 110 previously discussed. The roll may also include a hollow core 320 to receive a rod or similar device to spin as a user pulls the sheet of material 310 from the roll. The hollow core 320 may include a keyway or gear to assist with spin control as the sheet of material 310 is dispensed from the roll. The sheet of rolled-up material 310 includes a plurality of vertical perforated lines 324. The vertical perforated lines 324 separate the sheet of material 310 into large rectangular sections 330 and small rectangular sections 340. The large rectangular sections 330 act as a barrier 300 to the body or sides of a condiment container. The small rectangular sections 340 act as a barrier 300 to a lid or cap of the condiment container.

FIG. 4 shows a perspective view of another embodiment of the physical barrier 300 in a roll form. The—barrier 300 in FIG.4 is similar to the barrier 300 shown in FIG. 3. However, the barrier 300 in FIG. 4 includes a plurality of vertical perforated lines 324 as well as a horizontal perforated line 326. The horizontal perforated line 326 separates the large rectangular sections 330 that are used as a barrier 300 to the body or sides of a condiment container from the small rectangular sections 340 that are used as a barrier 300 to the lid or cap of the condiment container.

FIG. 5 shows a front view of the large rectangular section 324 of the material 310 used to cover the body or sides of the condiment container. FIG. 5 shows the large rectangular section 324 separated from other large sections 324 and small rectangular sections 326 via the perforated lines 324, 326 shown in FIGS. 3 and 4. The rectangular section 324 includes two back-to-back layers of the material 310. Alternatively, the rectangular section 324 may include a sleeve of material 310. The large rectangular section 324 includes two long edges 350 that are sealed. The large rectangular section 324 also includes two short edges 352, 354. The rectangular section 324 is sealed at one short edge 352 and open at the other short edge 354. The three sealed edges 350, 352 and one open edge 354 create a bag or sleeve that slides onto the condiment container as shown in FIG. 7.

FIG. 6 shows a front view of the small rectangular section 326 of the material 310 used to cover the cap or lid of the condiment container. FIG. 6 shows the small rectangular section 326 separated from the large sections 324 and other small rectangular sections 326 via the perforated lines 324, 326 shown in FIGS. 3 and 4. Similar to the large rectangular section in FIG. 5, the small rectangular section 326 includes back-to-back layers of the material 310. Alternatively, the rectangular section 326 may include a sleeve of the material 310. The small rectangular section 326 includes two short edges 360 that are sealed and two long edges 362, 364. The rectangular section 326 is sealed on one long edge 362 and open at the other long edge 354. The three sealed edges 360, 362 and one open edge 364 create a bag or sleeve that slides onto the cap or lid of the condiment container as shown in FIG. 8.

FIG. 7 shows the condiment container 200 covered by a large rectangular section 324. As shown in FIG. 7, an open edge 354 is capable of being slid down over the condiment container 200. The opposite closed edge 352 may part slightly so that the lid or cap 210 of the condiment container 200 may protrude through. Alternatively, the edge 352 may have a predefined opening to allow the lid or cap 210 and top portion of the condiment container 200 to extend therethrough. The rectangular section 324 protects a user from touching the condiment container 200 which may harbor microorganisms transferred from previous users. Once the user is finished using the condiment container 200, the user, a food establishment employee, or the next user may remove the used rectangular section 324. The food establishment employee or the next user may apply a new rectangular section 324 over the condiment container 200 or slide a new rectangular section 324 over the used barrier 300. The material 310 may be transparent or opaque. Additionally, the material 310 may be printed with terms or images as previously discussed.

FIG. 8 shows the condiment container 200 with the lid or cap 210 covered by a small rectangular section 326. As shown in FIG. 8, an open edge 364 may be slid down over the cap or lid 210 of the condiment container 200. The small rectangular section 326 may protect a user's hand from microorganisms on the cap or lid 210 as the hand removes or opens the cap or lid 210. The user, food establishment employee, or the next user may remove and apply a new rectangular section 326 or slide a new rectangular section 326 over the used barrier 300. The small rectangular section 326 may be used in conjunction with the large rectangular section 324 on the condiment container 200.

Alternatively, multiple rectangular sections 324 may be layered one on top of one other. The layered sections 324 can be attached to each other at one or more sealed edge 350, 352. The multi-layer barrier 300 may be slid onto the condiment container 200. A user may touch the outermost rectangular section 324. The current user, next user, or employee at the food establishment may rip or tear away the outermost rectangular section 324 to expose the next rectangular section 324. The next user thereby is protected from any possible cross-contamination of microorganisms transferred by the previous user.

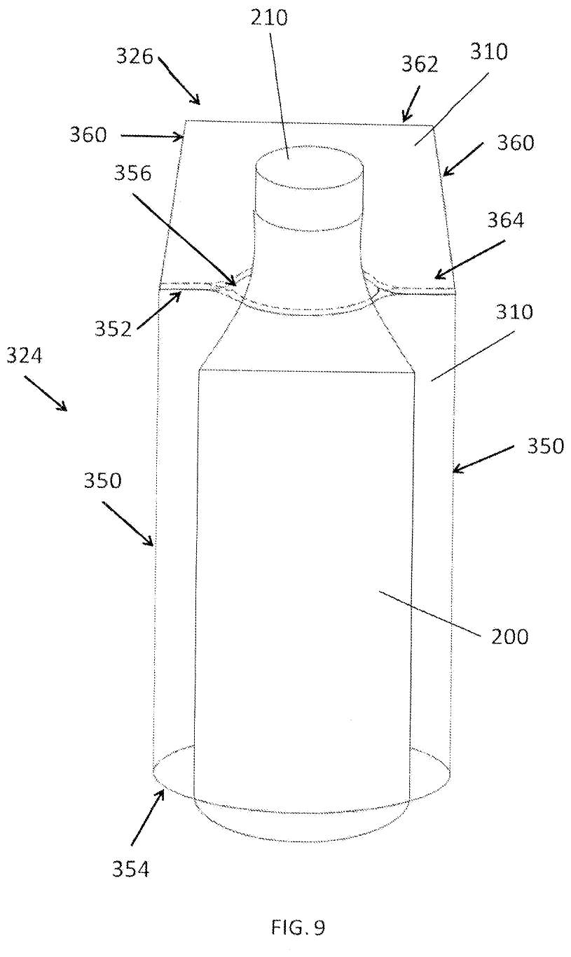

FIG. 9 shows the condiment container 200 covered by a large rectangular section 324 and the lid or cap 210 covered by a small rectangular section 326. As shown in FIG. 9, the large rectangular section 324 and the small rectangular section 326 may remain intact when applied to the condiment container 200. The edge 352 may part slightly so that the lid or cap 210 of the condiment container 200 may protrude through and into the small rectangle 326. After the sleeve-like large rectangular section 324 and small rectangular section 326 cover the condiment container 200 and lid or cap 210, the user may separate the large rectangular section 324 from the small rectangular section 326 by tearing along the perforated line 364. Tearing along perforated line 364 can also be accomplished by a twisting motion in conjunction with removing the lid or cap 210. The large rectangular section 324 is partially sealed at edge 352. The small rectangular section 326 may be partially sealed at edge 356.

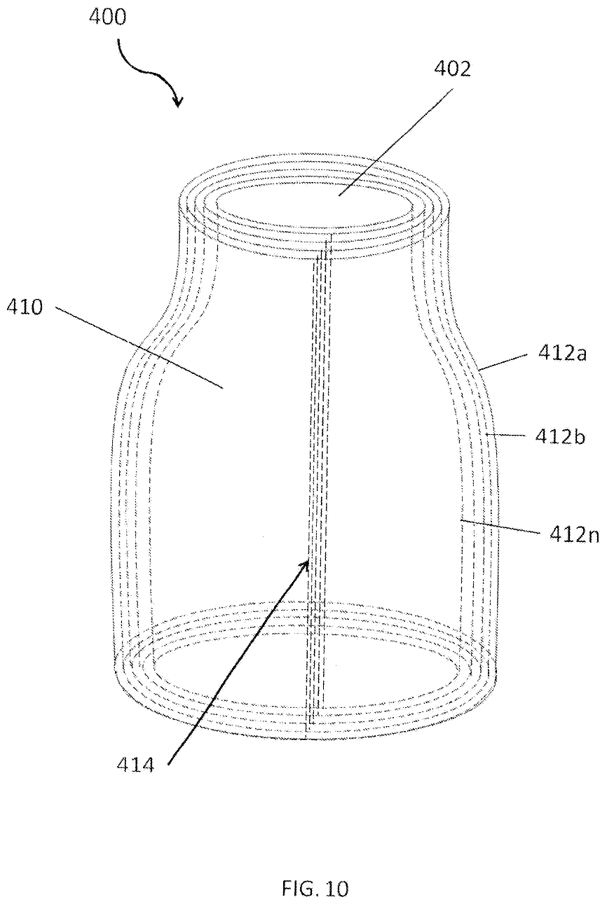

FIG. 10 shows another embodiment of the physical barrier 400 of the invention. The barrier 400 includes a hollow core 402. The hollow core 402 is configured to receive a condiment container. The barrier 400 may slide onto a condiment bottle. The barrier 400 may include an adhesive interior to stick to the condiment bottle, or alternately, the barrier 400 may fit onto the condiment bottle with a friction fit, fastener, cinch, ties, and the like. The barrier 400 comprises sheet material 410 which may be the same sheet material 110, 310 previously discussed. The sheet material 410 is rolled to create multiple layers 412a-n. Similar to the barrier 100 in FIG. 1, the sheet material 410 may include an adhesive side facing the interior and a non-adhesive or anti-stick side facing the exterior. Each layer 412a-n also may include a plurality of vertical perforated lines 414. A user may unwrap the outermost layer 412a of the material 410 and tear away the removed layer 412a at the vertical perforated line 414. Thus, the new revealed layer 412b is uncontaminated for the next user to touch. The next user may then remove the outermost layer 412b at a vertical perforated line 414 to reveal yet another layer 412c. The barrier 400 may be shaped to fit the contours of the condiment bottle, as shown in FIG. 10, or have an intercomponent (not shown) configured to receive any shaped condiment container.

All physical barriers 100, 300, 400, 600 may be modified to have a size and shape that work with a variety of different condiment container designs. Additionally, barriers 100, 300, 400, 600 may be modified and packaged for personal use and commercial use. Alterations may also be made to allow the barriers 100, 300, 600 to be dispensed from a variety of dispensers. For example, the barrier 100, 300, 600 may be modified to dispense from a portable dispenser, keychain dispenser, clip-style dispenser, commercial dispenser, or a self-container dispenser.

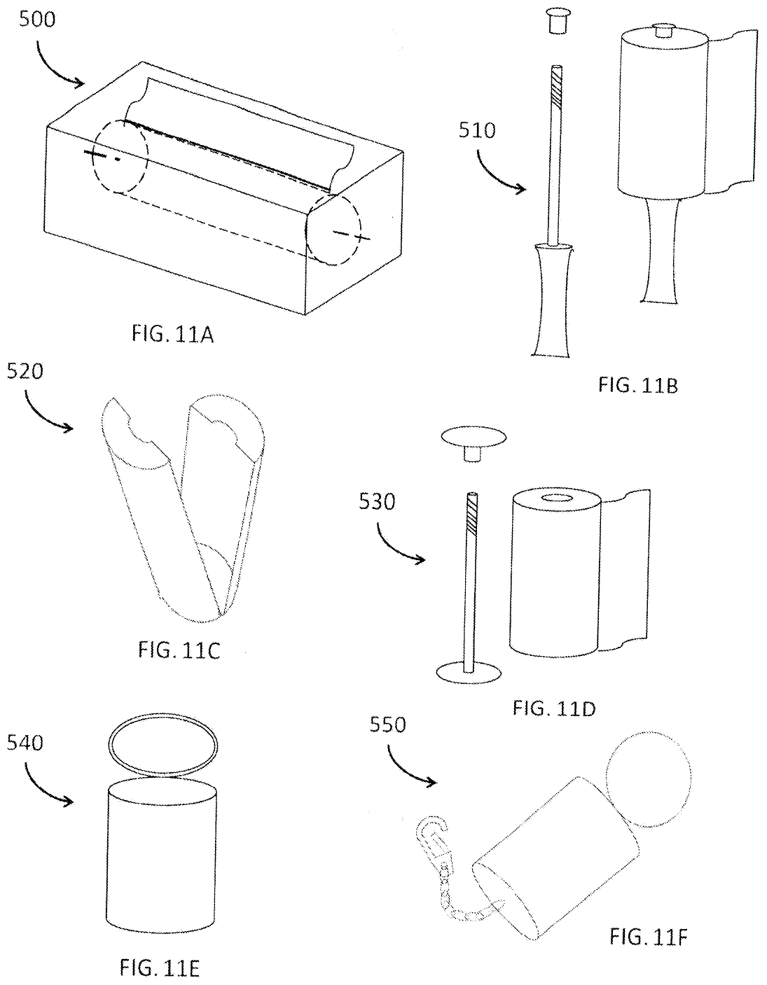

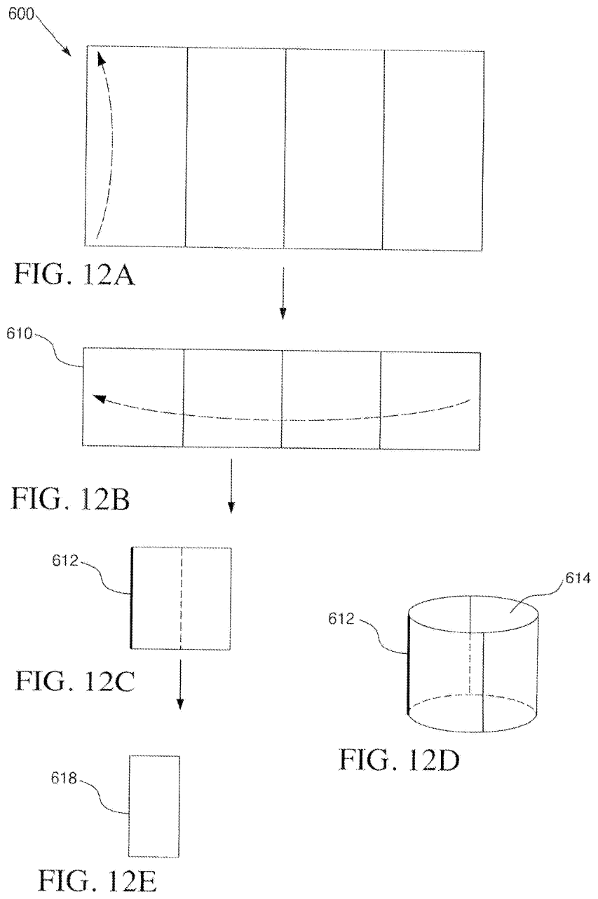

FIGS. 11A-11F show examples of dispensers or containers for the barriers 100, 300, 600 of the invention. FIG. 11A shows a box container 500. The box container 500 encloses the barrier 100, 300, 600. The box container 500 includes a dowel that runs thru the barrier 100, 300, 600 and allows the barrier to roll or spin on the dowel. Alternatively, the barrier 100, 300, 600 may be fixed to the dowel and the dowel spins relative to the box container 500. The box container 500 may be reusable or disposable. If the box container is reusable, there is a door in the box container 500 to allow access to the inside of the box container 500 and the dowel is removable to replace a used barrier roll 100, 300, 600.

FIG. 11B shows a hand roller dispenser 510. The hand roller dispenser 510 includes a handle having a male component and a female component. The male component may be a rod or dowel including a first end attached to the handle and a second end with threads. The dowel or rod extends through the barrier roll 100, 300, 600 with at least a portion of the threaded end extending past the end of the barrier roll 100, 300, 600. The female component holds the barrier roll 100, 300, 600 onto the dowel by screwing into the threaded end. The barrier roll 100, 300, 600 spins on the dowel or rod.

FIG. 11C shows a hinged case dispenser 520. The hinged case dispenser 520 may be used separately or in conjunction with the hand roller dispenser 510. The case dispenser 520 is a hollow housing that is sized and shaped to encase the barrier roll 100, 300, 600. An end of the case dispenser 520 may include an opening to allow the handle of the hand roller dispenser 510 to extend through. The case dispenser 520 may open via hinges at an end, as shown in FIG. 11C or via hinges along the side.

FIG. 11D shows a stand dispenser 530. The stand dispenser 530 includes a stand. A male component, such as a rod or dowel, is attached to the stand at a first end and includes threads at a second end. The male component is sized to extend through a barrier roll 100, 300, 600 with the threaded end extending past the roll. A female component screws onto the threads of the male component. The barrier roll 100, 300, 600 spins on the male component.

FIG. 11E shows a container dispenser 540. The container 540 may be a hollow cylindrical housing that is sized and shaped to encase a barrier roll 100, 300, 600. The container 540 includes a lid at one end that opens and closes via a hinge. The lid allows a user to insert and remove the barrier roll 100, 300, 600. The container 540 may also include a locking mechanism to lock the lid shut.

FIG. 11F shows a portable dispenser 550. The portable dispenser 550 may include a container dispenser 540 with a keychain or clip attached to an end of the container at the opposite end.

FIG. 12A-E show a further embodiment of the disposable, physical, barrier 600 of the invention. The barrier 600 is comprised of the same sheet material 110, 310 previously discussed. During manufacture, the barrier 600 is folded in half (12A). The folded sheet material 610 then is folded again (12B). The edge 612 of the twice-folded sheet material may be sealed by any suitable means, including, without limitation, crimping, folding, pressure sealing, pleating, adhesive, and the like. The twice-folded sheet material is folded one last time (12C). The final sheet material 618 is shown in FIG. 12E. The invention contemplates that a plurality of trice-folded sheet material 618 is placed in a receptacle (not shown), similar to a facial tissue or napkin receptacle. In use, a user removes one sheet material 618, unfolds it, and expands it into a cylindrical barrier 614 shape which may be placed over a container, such as a condiment container. The barrier 600 can be multi-functional in that it may also be used as a standard napkin. The invention contemplates that the rectangular barrier 600 may be manufactured in various dimensions, folds, and numbers of ply so that the cylindrical barrier 614 can be used for various sized containers.

Having thus described in detail a preferred selection of embodiments of the present invention, it is to be appreciated and will be apparent to those skilled in the art that many physical changes could be made to the disposable, physical barrier for containers without altering the inventive concepts and principles embodied therein. The present embodiments therefore are to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A disposable, physical barrier for a container for preventing transfer of microorganisms from one user to another user of the container, comprising:
at least a one-ply sheet including an adhesive side and a non-adhesive side, the sheet rolled onto itself to form a roll with the adhesive side facing an internal core of the roll and the non-adhesive side facing externally outward with regard to the roll, said sheet including a plurality of perforated horizontal lines and a plurality of perforated vertical lines, wherein at least a portion of the sheet is configured to be removed from the roll at one of the plurality of perforated vertical lines and at one of the plurality of perforated horizontal lines, said removed material further sized and configured to be applied to an outside of a container and lid or cap.

2. The disposable, physical barrier of claim 1, wherein the container is a condiment container.

3. The disposable, physical barrier of claim 1, wherein the internal core of the roll is configured to receive a rod to allow the roll to spin when a portion of the sheet is removed by a user.

4. The disposable, physical barrier of claim 1, wherein the sheet is manufactured from materials comprising plastic, paper, polymer, cardboard, metal, wax, or rice.

5. The disposable, physical barrier of claim 4, wherein the barrier sheet is folded in half a plurality of times, said folded material sealed at one edge to create a cylindrical shape configured to at least partially cover a portion of a condiment container.

6. The disposable, physical barrier of claim 4, wherein the sheet is a two-ply sheet having a plurality of vertical perforated lines, said plurality of vertical perforated lines placed between a first and a second rectangular section, said first rectangular section having a size that is larger than said second rectangular section, said first rectangular section including three sealed edges and an open edge when removed from the roll by one vertical perforated line of the plurality of vertical perforated lines, each removed larger rectangular section forming a sleeve configured to cover a condiment container, said second rectangular section including three sealed edges and an open edge when removed from the roll by at least one vertical perforated line of the plurality of vertical perforated lines, each removed smaller rectangular section forming a smaller sleeve configured to at least partially cover a lid of the condiment container.

7. The disposable, physical barrier of claim 4, wherein the sheet is a two-ply sheet having a plurality of vertical perforated lines and one horizontal perforated line, said plurality of vertical perforated lines separating the sheet into equal-sized rectangular sections, said horizontal perforated line separating the rectangular sections into a plurality of small rectangular sections and a plurality of large rectangular sections, wherein each of the plurality of large rectangular sections includes three sealed edges and an open edge when removed from the roll by one of the plurality of vertical perforated lines, each removed large rectangular section forming a sleeve configured to at least partially cover a condiment container, wherein each small rectangular section of the plurality of small rectangular section includes three sealed edges and an open edge when removed from the roll by the horizontal perforated line, each removed small rectangular section forming a sleeve configured to at least partially cover a lid of the condiment container.

8. The disposable, physical barrier of claim 7, wherein the open edge of the large rectangular section is configured to receive a top of the condiment container.

9. A disposable, physical barrier for a container for preventing transfer of microorganisms from one user to another user of the container, comprising:
a roll of material forming a plurality of layers, wherein each of the plurality of layers of the roll of the material includes an adhesive side, a non-adhesive side, and a vertical perforated line, said adhesive side facing an internal core of the roll and said non-adhesive side facing externally outward with regard to the roll, wherein the roll has an internal core configured to receive a container, wherein each of the plurality of layers of the material of the roll is configured to be removed by a user after use by the user.

10. The disposable, physical barrier of claim 9, wherein the roll of material is shaped to correspond to contours of the container.

11. The disposable, physical barrier of claim 10, wherein the container is a condiment container.

12. The disposable, physical barrier of claim 9, wherein the adhesive side includes at least one non-adhesive edge.

13. The disposable, physical barrier of claim 9, wherein the sheet is manufactured from materials comprising plastic, paper, polymer, cardboard, metal, wax, or rice.

14. A method for preventing transfer of microorganisms from one user to another user of a container using a disposable, physical barrier, the method comprising:
having a user remove a sheet material from a roll, dispenser or receptacle; and
applying the removed sheet material to an outside of a container.

15. The method of claim 14, wherein the container is a condiment container.

16. The method of claim 15, wherein the sheet material is manufactured from materials comprising plastic, paper, polymer, cardboard, metal, wax, or rice.

17. The method of claim 16, wherein the sheet is a one-ply sheet and includes an adhesive side and a non-adhesive side, the sheet rolled onto itself to form a roll with the adhesive side facing an internal core of the roll and the non-adhesive side facing externally outward with regard to the roll, said sheet including a plurality of perforated horizontal lines and a plurality of perforated vertical lines, wherein at least a portion of the sheet is configured to be removed from the roll at one of the plurality of perforated horizontal lines and at one of the plurality of perforated vertical lines, said removed material configured to be applied to an outside of the container.

18. The method of claim 16, wherein the sheet is a two-ply sheet having a plurality of vertical perforated lines, said plurality of vertical perforated lines placed between a first and a second rectangular section, said first rectangular section having a size that is larger than said second rectangular section, said first rectangular section including three sealed edges and an open edge when removed from the roll by one vertical perforated line of the plurality of vertical perforated lines, each removed larger rectangular section forming a sleeve configured to cover a condiment container, said second rectangular section including three sealed edges and an open edge when removed from the roll by at least one vertical perforated line of the plurality of vertical perforated lines, each removed smaller rectangular section forming a smaller sleeve configured to at least partially cover a lid of the condiment container.

19. The method of claim 16, wherein the sheet is a two-ply sheet having a plurality of vertical perforated lines and one horizontal perforated line, said plurality of vertical perforated lines separating the sheet into equal-sized rectangular sections, said horizontal perforated line separating the rectangular sections into a plurality of small rectangular sections and a plurality of large rectangular sections, wherein each of the plurality of large rectangular sections includes three sealed edges and an open edge when removed from the roll by one of the plurality of vertical perforated lines, each removed large rectangular section forming a sleeve configured to at least partially cover a condiment container, wherein each small rectangular section of the plurality of small rectangular section includes three sealed edges and an open edge when removed from the roll by the horizontal perforated line, each removed small rectangular section forming a sleeve configured to at least partially cover a lid of the condiment container.

20. The method of claim 16, wherein the sheet is configured in a roll forming a plurality of layers, wherein each of the plurality of layers of the roll of the material includes an adhesive side, a non-adhesive side, and a vertical perforated line, said adhesive side facing an internal core of the roll and said non-adhesive side facing externally outward with regard to the roll, wherein the roll has an internal core configured to receive a container, wherein each of the plurality of layers of the material of the roll is configured to be removed by a user after use by the user, wherein the roll of material is shaped to correspond to contours of the container.
